(19) United States
(12) Patent Application Publication
(10) Pub. No.: US 2023/0097696 A1
(43) Pub. Date: Mar. 30, 2023

(54) INFORMATION PROCESSOR AND INTERMEDIATION ASSISTANCE METHOD

(71) Applicant: Hitachi, Ltd., Tokyo (JP)

(72) Inventor: Kentaro WATANABE, Tokyo (JP)

(21) Appl. No.: 17/900,853

(22) Filed: Aug. 31, 2022

(30) Foreign Application Priority Data
Sep. 30, 2021 (JP) 2021-161829

(51) Int. Cl. G06Q 10/10

(52) U.S. Cl. CPC G06Q 10/101

(57) ABSTRACT

There is provided a technology that assists intermediation between a developer and a user prior to the development of a solution product. A server includes: an invitation/application management unit that performs use invitation using the solution product on the market place based on invitation information registered beforehand in the developer, that accepts an application by the user to the use invitation, and that sets a utilization project of the solution product by the user; a development influence degree calculation unit that calculates a development influence degree of the solution product on the utilization project; and a contract condition decision unit that decides a contract condition between the developer and the user based on the development influence degree.

### BACKGROUND

The present invention relates to an information processor and a method that assist intermediation between a developer of a solution product and a user.

Nowadays, with the progress of information processing technologies and communication technologies, the use of solution products that offers various information processing services to users is advancing. A business person (developer) who develops and operates such solution products accumulates expected sales from all users to settle an investment return plan in the stage of a development project. For example, there is an operation form in which users make a promise (make a commitment) to a developer beforehand on an utilization project of a solution product corresponding to their requests, the solution product is developed by the developer, and then the users start the use of the solution product. In such an operation form for a solution product, the developer settles an investment return plan based on the user's commitment, and can launch the development of the solution product, and thus a prior investment risk at the time of development can be reduced. In a typical development of a solution product, since a semi-made-to-order system that customizes the specifications corresponding to a user's request is often adopted, setting such an operation form is preferable.

In consideration of the situations as described above, in order to much further activate the development and use of a solution product, the significance is that a match is made between the need on the user side and the need on the developer side and the developer and the user are allowed to appropriately conclude a contract involved in the use of the solution product. In order to achieve this, a platform service, a transaction service, a market place service, and the like, which assist the intermediation between the developer of the solution product and the user, are demanded.

As a technology relating to an intermediation assistance between the developer of the solution product and the user, a technology described in Japanese Unexamined Patent Application Publication No. 2016-509721, for example, is known. Japanese Unexamined Patent Application Publication No. 2016-509721 discloses a technology of a cloud sourcing platform that is capable of disclosing information such as business information, which a developer of a product material has not been conventionally disclosed to investors, in cloud sourcing.

### SUMMARY

Preferably, in the development of the solution product, a utilization project committed beforehand by a user to the developer is shared, and the developer and the user reconcile the contents of the contract beforehand in consideration of an influence degree received by the developer beforehand in the case in which the utilization project is not achieved. However, since the technology disclosed in Japanese Unexamined Patent Application Publication No. 2016-509721 does not take these points into consideration, the technology is not capable of performing intermediation assistance between the developer and the user prior to the development of the solution product.

The present invention has been made in view of the problems, and it is a main object to provide a technology that assists intermediation between a developer and a user prior to the development of a solution product.

An information processor according to an aspect of the present invention assists intermediation between a developer who develops a solution product and a user who uses the solution, in which prior to development of the solution product, a market place that performs a transaction involved in use of the solution product is offered to the developer and the user.

An intermediation assistance method according to an aspect of the present invention offers a market place involved in a transaction of a solution product to a developer who develops the solution product and a user who uses the solution product using a computer prior to development of the solution product and assists intermediation between the developer and the user. The computer: performs a use invitation using the solution product on the market place based on invitation information registered beforehand in the developer: accepts an application by the user to the use invitation and sets a utilization project of the solution product by the user; calculates a development influence degree of the solution product on the utilization project; and decides a contract condition between the developer and the user based on the development influence degree.

According to the present invention, it is possible to provide a technology that assists intermediation between a developer and a user prior to the development of a solution product.

### BRIEF DESCRIPTION OF THE DRAWINGS

FIG. 1 is a block diagram showing the schematic configuration of a market place system for a solution product according to an embodiment of the present invention;

FIG. 2 is a diagram showing a specific example of the data structure of an invitation table;

FIG. 3 is a diagram showing a specific example of the data structure of an application table;

FIG. 4 is a diagram showing a specific example of the data structure of a project/result table;

FIG. 5 is a diagram showing a specific example of the data structure of a credit score table;

FIG. 6 is a diagram showing a specific example of the data structure of a contract conditions table;

FIG. 7 is a diagram showing a specific example of the data structure of a development influence degree calculation policy table;

FIG. 8 is a diagram showing a specific example of the data structure of a contract condition decision policy table;

FIG. 9 is a flowchart showing a flow of an application reception process;

FIG. 10 is a flowchart showing a flow of an agreement/adjustment process;

FIG. 11 is a flowchart showing a flow of a development influence degree calculation process;

FIG. 12 is a flowchart showing a flow of a dynamic review process;

FIG. 13 is a diagram showing a list display example of an invitation screen;

FIG. 14 is a diagram showing a detailed display example of the invitation screen; and

FIG. 15 is a diagram showing an example of an application screen.

### DETAILED DESCRIPTION

In the following, an embodiment of the present invention will be described with reference to the drawings. Note that the embodiment that will be described below does not limit the present invention, and all components and combinations of the components described in the embodiment are not essential for the solutions of the present invention.

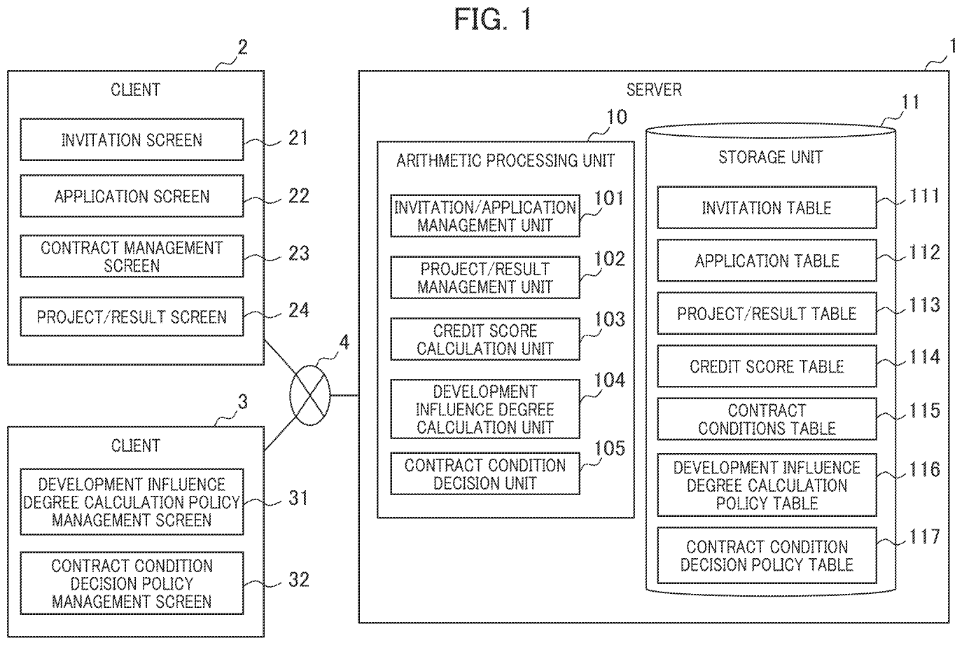

FIG. 1 is a block diagram showing the schematic configuration of a market place system for a solution product according to an embodiment of the present invention (in the following, simply referred to as “a market place system”). The market place system shown in FIG. 1 is an information processing system in which prior to the development of a solution product offering services to a user using an information processing technology, market places are offered to a developer who develops the solution product and the user who uses the solution product in order to make a transaction involved in the use of the solution product. Thus, the market place system of the present embodiment assists intermediation between the developer and the user prior to the development of the solution product, and promotes the development and use of the solution product.

As shown in FIG. 1, for example, the market place system of the present embodiment is configured including a server 1, a client 2, and a client 3. The server 1, the client 2, and the client 3 are all information processors that perform predetermined arithmetic processing, and are implemented using a computer. Note that the server 1, the client 2, and the client 3 may be configured of individual computers or may be configured combining a plurality of computers.

The server 1, the client 2, and the client 3 are connected to each other through a network 4. Thus, the market place system of the present embodiment is configured of a typical server-client information processing system. Note that the network 4 may be the Internet or may be an intranet.

The server 1 is an information processor that performs various arithmetic processes and information management of the market place system of the present embodiment. For example, the server 1 manages the application status of users who have been invited beforehand prior to the initiation of the development of a solution product by a developer, manages the contents of the contract concluded between the developer and the user, and manages a predefined utilization project of the solution product in service and use results, and the like.

The server 1 is architected using a web server, for example, and has an arithmetic processing unit 10 and a storage unit 11. The arithmetic processing unit 10 is configured using a central processing unit (CPU), a read only memory (ROM), a random access memory (RAM), and the like, for example, and has, as functions, an invitation/application management unit 101, a project/result management unit 102, a credit score calculation unit 103, a development influence degree calculation unit 104, and a contract condition decision unit 105, which are functional blocks. The arithmetic processing unit 10 executes various programs stored in the storage unit 11, and thus can achieve these functions. Note that the detail of the functional blocks of the arithmetic processing unit 10 will be described later.

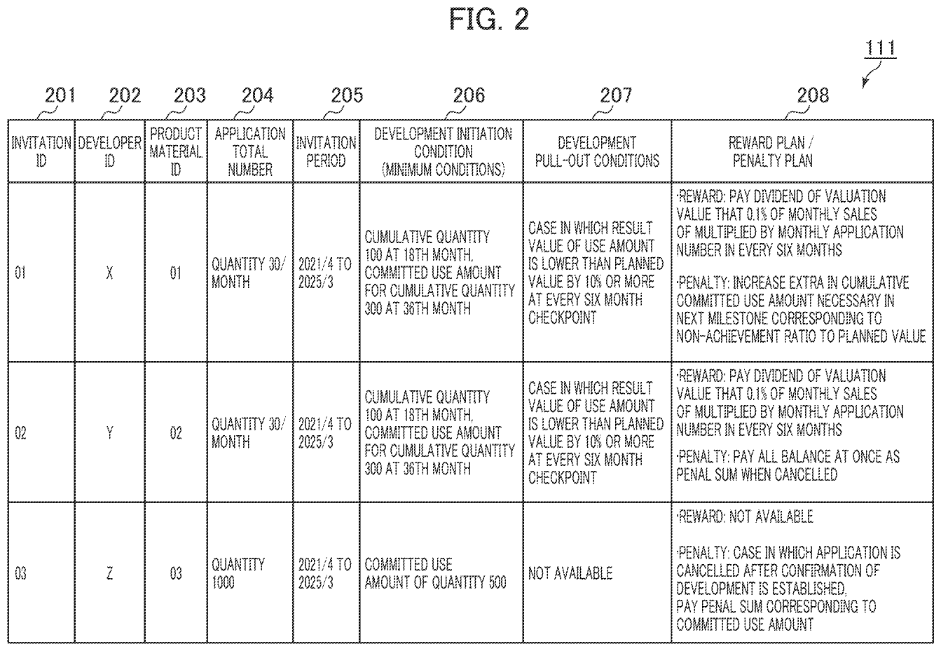

For example, the storage unit 11 is configured using a recording medium including a hard disk drive (HDD) and a solid-state disk (SSD). The storage unit 11 records, in addition to the programs that implement the functional blocks of the arithmetic processing unit 10, pieces of information of an invitation table 111, an application table 112, a project/result table 113, a credit score table 114, a contract conditions table 115, a development influence degree calculation policy table 116, and a contract condition decision policy table 117. Note that the detail of the pieces of information of the storage unit 11 will be described with reference to FIGS. 2 to 8 later.

The invitation/application management unit 101 invites applications for the use of a solution product based on invitation information registered in a developer beforehand on a market place offered by the server 1. The invitation/application management unit 101 receives applications to the use invitation by the users, and sets a utilization project of the solution product by the users. Note that invitation information by the developer for the invitation of the use of the solution product is acquired beforehand by the invitation/application management unit 101, and stored as the invitation table 111 in the storage unit 11. The pieces of application information from the users received by the invitation/application management unit 101 are stored in as the application table 112 in the storage unit 11.

The project/result management unit 102 manages the utilization project of the solution product set by the invitation/application management unit 101 and the use result of the solution product by the user. The project/result management unit 102 compares the utilization project with the use result, and can decide a reward or a penalty to the user based on the comparison result. The project/result management unit 102 performs management and comparison between the utilization project and the use result using the project/result table 113 stored in the storage unit 11.

The credit score calculation unit 103 calculates a credit score that is the index of the degree of the credit to the utilization project set beforehand by the users based on the comparison result between the utilization project and the use result by the project/result management unit 102. The result of the calculation of the credit score by the credit score calculation unit 103 is stored as the credit score table 114 in the storage unit 11.

The development influence degree calculation unit 104 calculates the development influence degree of the solution product to the utilization projects of the users. The development influence degree means expresses the index of the influence degree in which the utilization project for every user affects the development project of the solution product, and expresses that a utilization project having a higher development influence degree is a significant utilization project to the development project of the solution product. The calculated result of the development influence degree by the development influence degree calculation unit 104 is stored as a part of the application table 112 or the project/result table 113 together with the other pieces of information.

The contract condition decision unit 105 decides the contract conditions between the developer and the user concluded at the time of starting the development of the solution product based on the conditions presented in the use invitation by the developer, the development influence degree calculated by the development influence degree calculation unit 104, and the like. The contract conditions decided by the contract condition decision unit 105 are stored as the contract conditions table 115 in the storage unit 11, and presented to both of the developer and the user. The developer and the user consent the presented contract conditions to conclude the development of the solution product and the contract involved in use to each other. Note that the contract between the developer and the user may be electronically consented on the server 1 or may be separately consented using a written document and the like.

The client 2 is a client terminal when the developer of the solution product and the user use the market place system, and is architected using a personal computer (PC) and the like. Note that FIG. 1 shows one client 2 alone, and actually, a plurality of terminals is connected to the server 1 as the clients 2 corresponding to the numbers of developers and users participating the market place.

The client 2 has a display device, not shown, and is formed to display various screens such as an invitation screen 21, an application screen 22, a contract management screen 23, and a project/result screen 24. The invitation screen 21 is a screen that offers invitation information relating to a solution product under a use invitation registered by the developer. The application screen 22 is a screen that receives inputs of information necessary for the user to apply the solution product under the use invitation. The contract management screen 23 is a screen that presents the contract conditions when the contract involved in the development of the solution product are concluded between the developer and manages the contents of the concluded contract. The project/result screen 24 is a screen that the utilization project of the solution product and the management status of the use result are confirmed by the project/result management unit 102.

The developer of the solution product and the user access the server 1 using a web browser and any other browser, for example, and causes the client 2 to display the screens to perform a predetermined operation, and thus various functions offered by the market place system of the present embodiment can be used. Note that screens that can be displayed in the client 2 are not limited to these screens, and the client 2 may display other screens.

The client 3 is a client terminal used by a service administrator who operates and manages the market place system of the present embodiment, and is architected using a PC and the like. Note that FIG. 1 shows one client 3 alone, and a plurality of terminals may be connected to the server 1 as clients 3.

The client 3 has a display device, not shown, and is formed to display various screens such as a development influence degree calculation policy management screen 31, and a contract condition decision policy management screen 32 on this display device. The development influence degree calculation policy management screen 31 is a screen that manages the contents of the development influence degree calculation policy table 116 stored in the storage unit 11. The contract condition decision policy management screen 32 is a screen that manages the contents of the contract condition decision policy table 117 stored in the storage unit 11.

The service administrator of the market place system access the server 1 using a web browser and any other browser, for example, and causes the client 3 to display the screens to perform a predetermined operation, and thus the service administrator can edit the development influence degree calculation policy table 116 and the contract condition decision policy table 117, and can manage the market place system of the present embodiment. Note that screens that can be display on the client 3 are not limited to the screens, and the client 3 may display other screens.

Next, the detail of the pieces of information stored in the storage unit 11 will be described.

FIG. 2 is a diagram showing a specific example of the data structure of the invitation table 111. When the developer performs a use invitation of the solution product, the entries of the invitation table 111 are set for each case of the use invitation. As shown in FIG. 2, the invitation table 111 is configured including, for example, an invitation ID field 201, a developer ID field 202, a product material ID field 203, an application total number field 204, an invitation period field 205, a development initiation condition field 206, a development pull-out conditions field 207, and a reward/penalty plan field 208. In the market place system of the present embodiment, the pieces of information corresponding to these fields are stored individually in the entries of the invitation table 111 and stored in the storage unit 11, and thus the invitation information relating to the cases under the use invitation is formed.

The invitation ID field 201 is a field storing an identifier that uniquely identifies the cases under the use invitation.

The developer ID field 202 is a field storing an identifier that uniquely identifies a developer who is an invitation source of each case.

The product material ID field 203 is a field storing an identifier that uniquely identifies solution products targeted for the use invitation.

The application total number field 204 is a field storing the number of quantities that a user is applicable to the cases under the use invitation.

The invitation period field 205 is a field storing invitation periods of the cases under the use invitation.

The development initiation condition field 206 is a field storing information relating to the development initiation condition of the solution products targeted for the use invitation. The information relating to the development initiation condition is information expressing the conditions for launching the development of the solution product invited by the developer, which is, for example, a lower limit (minimum use amount) of a total of the use amount of the solution product committed by the users at the time of application and any other information. Specifically, for example, in the case in which the total of the use amount of a solution product committed by the users at the time of application exceeds the minimum use amount shown in the development initiation condition field 206, the developer determines that a return on investment is expected to the development of the solution product under invitation while taking into consideration of some uncertainty, and thus the developer can launch the development of the solution product. In this case, after the development is finished, the solution product is offered to the users who have applied in the invitation period. However, on the other hand, in the case in which the total of the use amount of the solution product committed by the users at the time of application falls short of the minimum use amount shown in the development initiation condition field 206, the developer determines that a return on investment is not expected to the development of the solution product, and the developer can decide not to launch the development.

The development pull-out conditions field 207 is a field storing information relating to development pull-out conditions for the solution products targeted for the use invitation. The information relating to the development pull-out conditions is information expressing the conditions for pulling out of the development or the operation of the solution product invited by the developer. The developer sets the information relating to the development pull-out conditions in the development pull-out conditions field 207, and thus the developer can perform the invitation of the use of the solution product with the disclosure of the information to the user beforehand. Thus, in the case in which the use of the solution product under development or after developed does not proceed as the initial project or as planned a return on investment is not expected, the developer can pull out of the development or the operation of the solution product, and thus it is possible to suppress the expansion of losses.

The reward/penalty plan field 208 is a field storing information on a reward and a penalty offered to or charged on the user corresponding to the status of the use of the solution products targeted for the use invitation. When the status of the use of the solution product achieves a predetermined condition, for example, the developer declares at the time of use invitation that a reward is given to the user, and thus the developer can make an incentive for the user to apply or use the solution product. Alternatively, for example, when the status of the use of the solution product fits a predetermined condition that becomes a factor of hindrance to the developer, the developer declares at the time of use invitation that a penalty is given to the user, and thus the developer can suppress a hindrance action by the user of the solution product. At the time of conclusion of the contract of the development of the solution product, in some cases, the developer and the user adjust reward conditions or penalty conditions in consideration of various premises. The reward conditions or the penalty conditions, which are the base of adjustment can be stored in the reward/penalty plan field 208 prior to the adjustment.

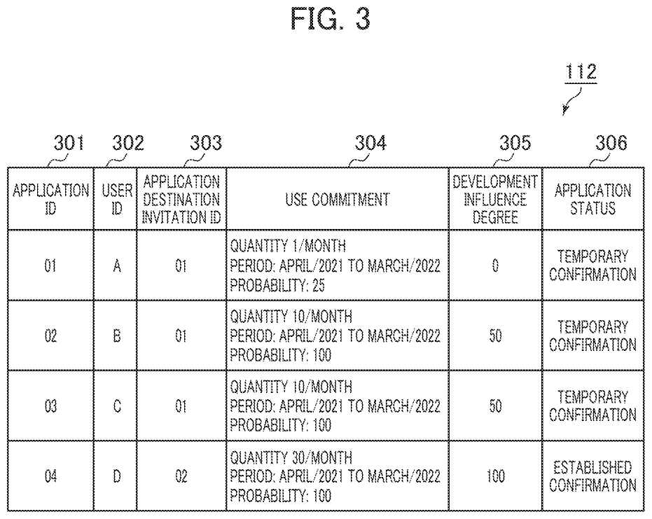

FIG. 3 is a diagram showing a specific example of the data structure of the application table 112. When the user applies the case under the use invitation, the entries of the application table 112 are set to each application. As shown in FIG. 3, the application table 112 is configured including an application ID field 301, a user ID field 302, an application destination invitation ID field 303, a use commitment field 304, a development influence degree field 305, and an application status field 306, for example. In the market place system of the present embodiment, to the entries of the application table 112, the pieces of information corresponding to these fields are stored in the storage unit 11, and thus application information relating to the applications performed by the users is formed.

The application ID field 301 is a field storing an identifier that uniquely identifies the applications performed by the users to the case under the use invitation.

The user ID field 302 is a field storing an identifier that uniquely identifies the users applied to the case under the use invitation.

The application destination invitation ID field 303 is a field storing an identifier that uniquely identifies a solution product, which is an application destination. The identifier corresponding to that stored in the product material ID field 203 in the invitation table 111 in FIG. 2 is stored here. These identifiers are checked against each other, the developer can identify which solution product in the solution products under the use invitation the user applies.

The use commitment field 304 is a field storing commitment information relating to the use conditions that the users commit themselves to the developer at the time of application. In application to the case under the use invitation, the user of the solution product make a promise to the developer beforehand (make a commitment) on the use period of the solution product or the use amount. The commitment information is information expressing the use period or the use amount at this time. Note that in addition to the use period or the use amount, probability information and the like expressing probabilities of these values assumed by the user beforehand may be included in the commitment information.

The development influence degree field 305 is a field storing the values of the development influence degree calculated by the development influence degree calculation unit 104 to the solution products to which the user is applied. Note that as described above, the development influence degree is the index of the influence degree in which the utilization project set by the user at the time of application affects the development project of the solution product.

The application status field 306 is a field storing the status of the application. This field stores status information such as “undecided”, “temporary confirmation”, and “established confirmation” corresponding to the development project status of the solution products that are the application destinations.

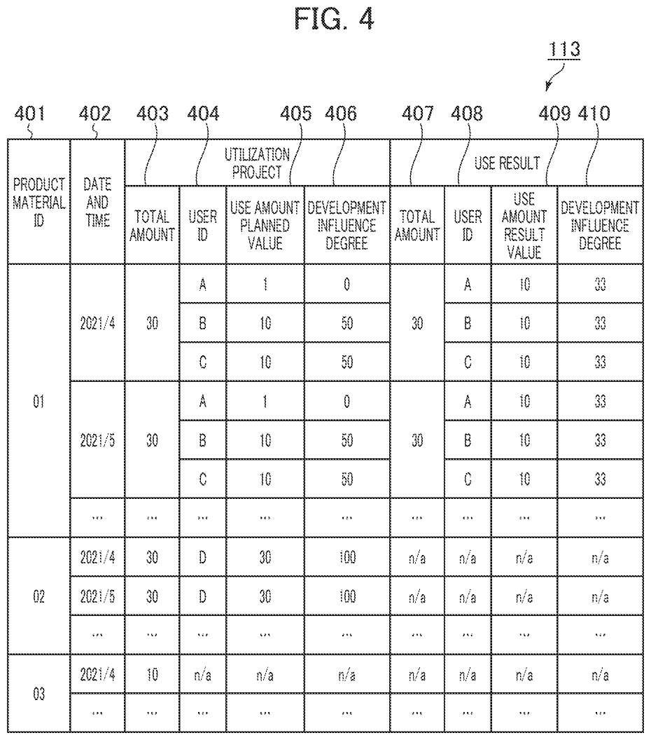

FIG. 4 is a diagram showing a specific example of the data structure of the project/result table 113. When the operation of the solution product to which the use invitation is made, the entries of the project/result table 113 are set based on information on the utilization project and the use result found by totalizing the operation status of the solution product for each month. As shown in FIG. 4, the project/result table 113 is configured including, for example, a product material ID field 401, a date and time field 402, a total amount field 403, a user ID field 404, a use amount planned value field 405, a development influence degree field 406, a total amount field 407, a user ID field 408, a use amount result value field 409, and a development influence degree field 410. In the market place system of the present embodiment, the pieces of information corresponding to these fields are stored individually in the entries of the project/result table 113, and stored in the storage unit 11, and thus the utilization project of the solution product in service and the use result are managed.

The product material ID field 401 is a field storing an identifier that uniquely identifies the solution product. Similarly to the application destination invitation ID field 303 in the application table 112 in FIG. 3, this field stores the identifier corresponding to the identifier stored in the product material ID field 203 in the invitation table 111 in FIG. 2. These identifiers are checked against each other, and thus information on which solution product of the solution products to which the user applies corresponding to the use invitation of the developer can be identified.

The date and time field 402 is a field storing a monthly period for totalization.

The total amount field 403 is a field storing the total amount of the use amount planned value of the solution product in the monthly periods targeted for totalization. The value of the total amount field 403 can be found by summing up the use amounts committed on the utilization project set by the users at the time of application for every monthly period, for example.

The user ID field 404 is a field storing an identifier that uniquely identifies the users targeted for totalization in the utilization project. This field stores the identifier corresponding to the identifier stored in the user ID field 302 in the application table 112 in FIG. 3.

The use amount planned value field 405 is a field storing the planned value of the use amount of the solution product for each user in the monthly periods targeted for totalization. The value of the use amount planned value field 405 can be found from the use amount committed on the utilization project set by the users at the time of application, for example.

The development influence degree field 406 is a field storing the value of the development influence degree calculated from the planned value of the use amount of the solution product for each user in the monthly periods targeted for totalization. The value of the development influence degree field 406 is calculated by the development influence degree calculation unit 104 based on the use amount committed on the utilization project set by the users at the time of application, for example.

The total amount field 407 is a field storing the total amount of the use amount result value of the solution product in the monthly periods targeted for totalization. The value of the total amount field 407 can be found by summing up the use amount that is actually used by the users for every monthly period, for example.

The user ID field 408 is a field storing an identifier that uniquely identifies the users targeted for totalization of the use result. Similarly to the user ID field 404, this field stores the identifier corresponding to the identifier stored in the user ID field 302 in the application table 112 in FIG. 3.

The use amount result value field 409 is a field storing the result value of the use amount of the solution product for every user in the monthly periods targeted for totalization. The value of the use amount result value field 409 can be found from the breakdown of the use amount for every user in the use result of the solution product, for example.

The development influence degree field 410 is a field storing the value of the development influence degree calculated from the result value of the use amount of the solution product for every user in the monthly periods targeted for totalization. The value of the development influence degree field 410 is calculated by the development influence degree calculation unit 104 based on the breakdown of the use amount for every user in the use result of the solution product, for example.

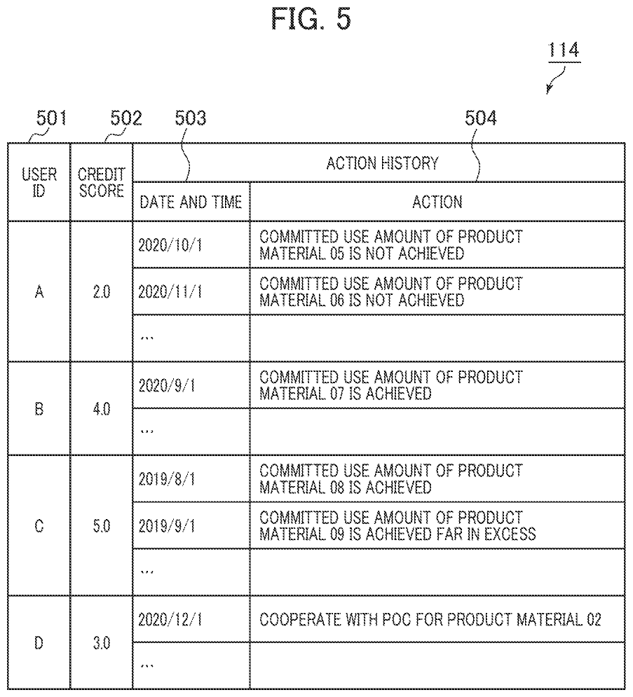

FIG. 5 is a diagram showing a specific example of the data structure of the credit score table 114. The entries of the credit score table 114 is set for every user of the solution product. As shown in FIG. 5, the credit score table 114 is configured including, for example, a user ID field 501, a credit score field 502, an action history date and time field 503, and an action history action field 504. In the market place system of the present embodiment, the pieces of information corresponding to these fields are stored individually in the entries of the credit score table 114 and stored in the storage unit 11, and thus the action history of the users relating to the use of the solution product and the credit scores of the users calculated based on the action history are managed.

The user ID field 501 is a field storing identification information that uniquely identifies the users. Similarly to the user ID field 404 in the project/result table 113 in FIG. 4, this field stores identification information corresponding to the identifiers stored in the user ID field 302 in the application table 112 in FIG. 3.

The credit score field 502 is a field storing the credit score relating to the user identified from the identification information of the user ID field 501. The value of the credit score field 502 is calculated by the credit score calculation unit 103 based on the action history for every user in the use result of the solution product, for example.

The action history date and time field 503 is a field storing information the date and time on which the action is taken by the user regarding the action history of the user targeted for recording.

The action history action field 504 is a field storing the contents of the action history of the user targeted for recording. This field stores information expressing whether to achieve the use amount committed by the users at the time of application, for example.

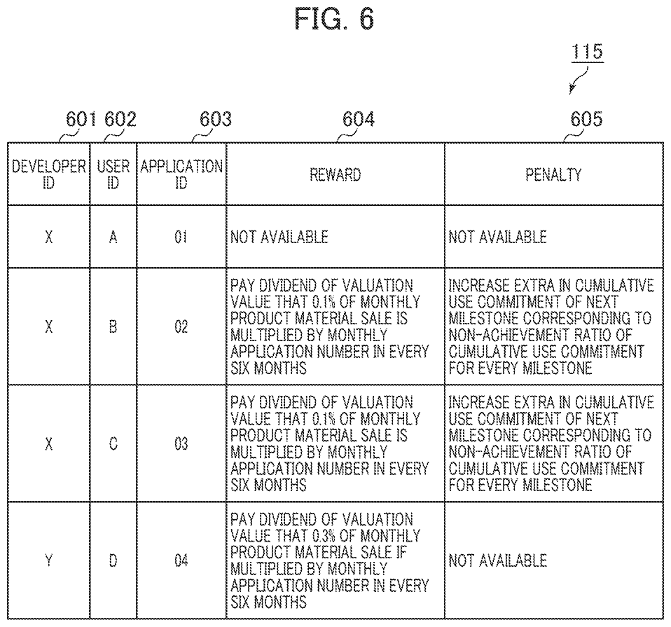

FIG. 6 is a diagram showing a specific example of the data structure of the contract conditions table 115. The entries of the contract conditions table 115 is set to every combination of the developer of the solution product and the user. As shown in FIG. 6, the contract conditions table 115 is configured including, for example, a developer ID field 601, a user ID field 602, an application ID field 603, a reward condition field 604, and a penalty condition field 605. In the market place system of the present embodiment, the pieces of information corresponding to these fields are stored individually in the entries of the contract conditions table 115 and stored in the storage unit 11, and thus the reward conditions or the penalty conditions for the contract conditions individually adjusted between the developer and the user are managed.

The developer ID field 601 is a field storing identification information that uniquely identifies the developer of the solution product. This field stores identification information corresponding to information stored in the developer ID field 202 in the invitation table 111 in FIG. 2.

The user ID field 602 is a field storing identification information that uniquely identifies the users. Similarly to the user ID field 404 in the project/result table 113 in FIG. 4 or the user ID field 501 in the credit score table 114 in FIG. 5, this field stores the identification information corresponding to the identifiers stored in the user ID field 302 in the application table 112 in FIG. 3.

The application ID field 603 is a field storing an identifier that uniquely identifies the application performed by the user for every solution product. This field stores the identifier corresponding to the identifier stored in the application ID field 301 in the invitation table 111 in FIG. 2.

The reward condition field 604 is a field storing information expressing the conditions for the reward offered from the developer to the user in the contract involved in the use of the solution product concluded between the developer and the user.

The penalty condition field 605 is a field storing information expressing the conditions for the penalty charged to the user by the developer in the contract involved in the use of the solution product concluded between the developer and the user.

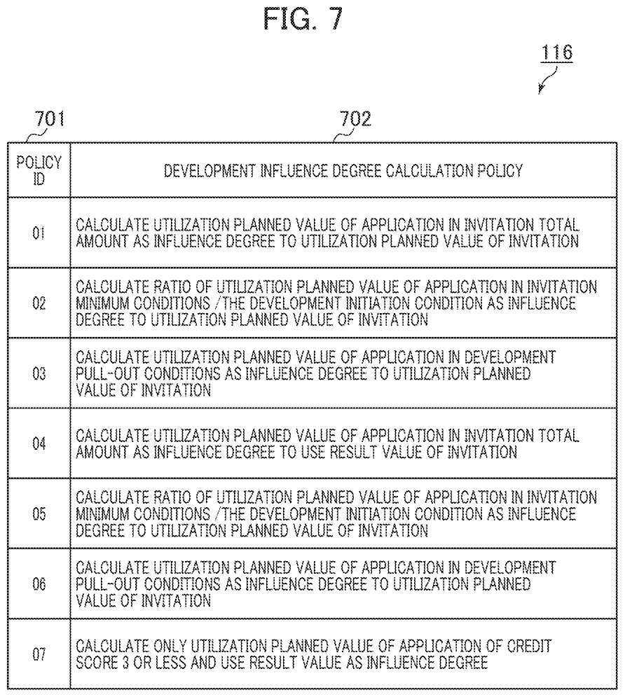

FIG. 7 is a diagram showing a specific example of the data structure of the development influence degree calculation policy table 116. The entries of the development influence degree calculation policy table 116 is set to each of the contents of rules (policy) defined beforehand regarding the calculation method of the development influence degree. As shown in FIG. 7, the development influence degree calculation policy table 116 is configured including, for example, a policy ID field 701 and a development influence degree calculation policy field 702. In the market place system of the present embodiment, the pieces of information corresponding to these fields are stored individually in the entries of the development influence degree calculation policy table 116 and stored in the storage unit 11, and thus the policy used at the time of calculating the development influence degree by the development influence degree calculation unit 104 is managed.

The policy ID field 701 is a field storing identification information that uniquely identifies the policy regarding the calculation of the development influence degree.

The development influence degree calculation policy field 702 is a field storing information expressing the contents of the policy identified from the identification information in the policy ID field 701. The development influence degree calculation unit 104 can calculate the development influence degree to the utilization projects of the users of the solution product according to the contents of the policy described in the development influence degree calculation policy field 702.

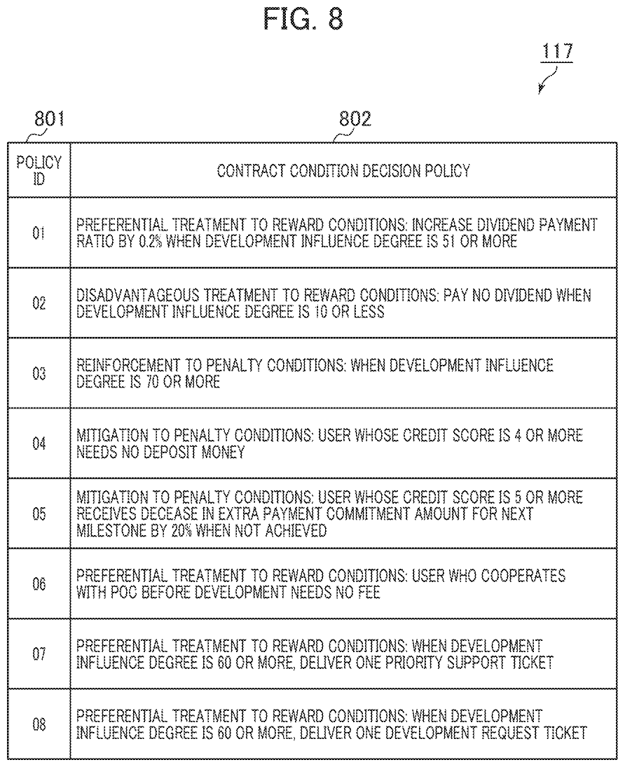

FIG. 8 is a diagram showing a specific example of the data structure of the contract condition decision policy table 117. The entries of the contract condition decision policy table 117 are set to each of the contents of rules (policy) defined beforehand regarding the decision method for the contract conditions between the developer and the user. As shown in FIG. 8, the contract condition decision policy table 117 is configured including, for example, a policy ID field 801 and a contract condition decision policy field 802. In the market place system of the present embodiment, the pieces of information corresponding to these fields are stored individually in the entries of the contract condition decision policy table 117 and stored in the storage unit 11, and thus the policy used at the time of deciding the contract conditions between the developer and the user concluded at the time of starting the development of the solution product by the contract condition decision unit 105 is managed.

The policy ID field 801 is a field storing identification information that uniquely identifies the policy regarding the decision of the contract conditions.

The contract condition decision policy field 802 is a field storing information expressing the contents of the policy identified from the identification information in the policy ID field 801. The contract condition decision unit 105 can decide the contract conditions at the time of concluding the contract beforehand between the developer and the user to the use of the solution product according to the contents of the policy described in the contract condition decision policy field 802.

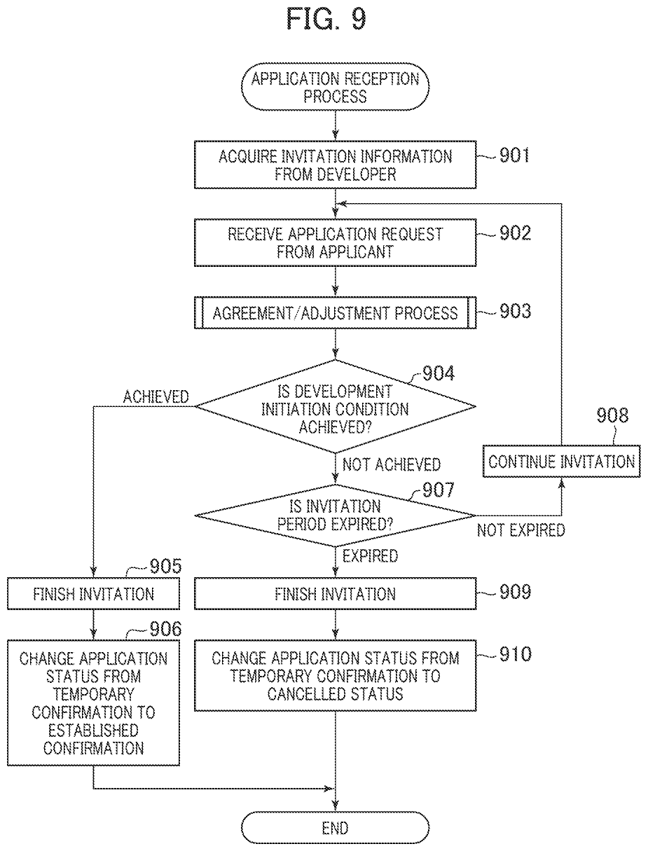

Next, the detail of the arithmetic processing executed in the arithmetic processing unit 10 of the server 1 will be described. In the market place system of the present embodiment, the arithmetic processing unit 10 executes a predetermined program to function as the invitation/application management unit 101, the project/result management unit 102, the credit score calculation unit 103, the development influence degree calculation unit 104, and the contract condition decision unit 105, and thus a market place that performs the transaction involved in the use of the solution product is offered to the developer and the user. In the following, referring to flowcharts in FIGS. 9 to 12, specific examples of processes performed by the functional blocks, the invitation/application management unit 101, the project/result management unit 102, the credit score calculation unit 103, the development influence degree calculation unit 104, and the contract condition decision unit 105 will be described.

FIG. 9 is a flowchart showing a flow of an application reception process executed when the developer makes a use invitation prior to the development of a solution product, receives applications from users and decides whether to adopt the application. The process shown in the flowchart in FIG. 9 is executed, for example, when the server 1 receives a registration request for the use invitation transmitted by the developer through the client 2, when the server 1 receives an application request from the application to the case under the use invitation, and the like. In the case in which the solution product under the use invitation is present in the server 1 at the present time, the process shown in the flowchart in FIG. 9 may be executed at fixed time intervals to the cases.

In Step 901, the invitation/application management unit 101 acquires invitation information transmitted from the developer. Here, for example, the developer operates the client 2 to make registration, and receives the invitation information transmitted from the client 2 to the server 1, and thus acquires the invitation information relating to the invitation of the use of the solution product from developer.

In Step 902, the invitation/application management unit 101 accepts an application request from an applicant of the invitation information acquired in Step 901. Here, for example, a user who desires the use of the solution product under the use invitation from which the invitation information is acquired and who applies the case of the use invitation is referred to as an applicant. The applicant operates the client 2 to make registration, and receives the application information transmitted from the client 2 to the server 1, and thus the application request from the applicant relating to the invitation of the use of the solution product is accepted.

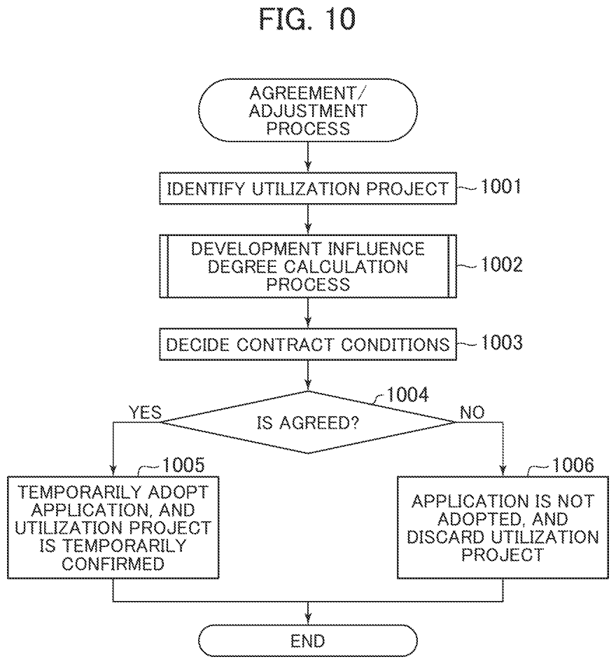

In Step 903, the invitation/application management unit 101 performs an agreement/adjustment process relating to the use of the solution product between the developer and the applicant (user). Here, the utilization project of the solution product presented by the applicant in the application request accepted in Step 902 is shared between the developer and the applicant, and the contract of the development of the solution product conditions is adjusted between the developer and the applicant based on the utilization project. After the developer and the applicant agree on the contract conditions, the application is temporarily adopted. Note that the detail of the agreement/adjustment process executed in Step 903 will be described later with reference to FIG. 10.

In Step 904, the invitation/application management unit 101 determines whether the case targeted for processing achieves the development initiation condition. Here, for example, the case in which the application is temporarily adopted in the agreement/adjustment process in Step 903 is a target for processing, reference is made to the information expressed in the development initiation condition field 206 in the invitation table 111 in FIG. 2, and thus the development initiation condition for the case is acquired, and it is determined whether the development initiation condition is achieved. As a result, in the case in which the development initiation condition is achieved, the process goes to Step 905, whereas in the case in which the development initiation condition is not achieved, the process goes to Step 907.

In Step 905, the invitation/application management unit 101 ends the invitation of the case in which it is determined that the development initiation condition is achieved in Step 904. Thus, the case the invitation of the use of the solution product corresponding to the case is closed, and the developer starts the development of the solution product. Note that even after the process in Step 905 is not executed and the development is started, the invitation of the use of the solution product may be continued.

In Step 906, the invitation/application management unit 101 changes the application status from the users to the case in which the invitation is ended in Step 905 from “temporary confirmation” to “established confirmation”. The contents of changes in the application status is reflected in the application status field 306 in the application table 112 in FIG. 3. After the process in Step 906 is executed, the invitation/application management unit 101 ends the application reception process shown in the flowchart in FIG. 9.

In Step 907, the invitation/application management unit 101 determines whether the invitation period of the case targeted for processing is expired. Here, for example, reference is made to the information expressed in the invitation period field 205 in the invitation table 111 in FIG. 2 as the cases under the use invitation is a target for processing, the invitation period of the case is acquired, and it is determined whether the date and time at the present time is within the invitation period. As a result, in the case in which the date and time at the present time are within the invitation period, the process goes to Step 908, whereas in the case in which it is determined that the date and time are out of the invitation period, it is determined that the period is expired, and the process goes to Step 909.

In Step 908, the invitation/application management unit 101 continues the invitation of the case, and returns to Step 902. Thus, in the server 1, the acceptance of the application request from the applicant is continued.

In Step 909, the invitation/application management unit 101 ends the invitation of the case in which it is determined that the invitation period is expired in Step 907. Thus, the invitation of the use of the solution product corresponding to the case is canceled, and the developer abandons the development of the solution product. That is, in the case in which the invitation period is expired, the invitation/application management unit 101 ends the invitation of the use of the solution product even though the development initiation condition is not achieved.

In Step 910, the invitation/application management unit 101 changes the application status from the users to the case in which the invitation is ended in Step 909 from “temporary confirmation” to “cancelled status”. The contents of changes in the application status are reflected in the application status field 306 in the application table 112 in FIG. 3. After the process in Step 910 is executed, the invitation/application management unit 101 ends the application reception process shown in the flowchart in FIG. 9.

FIG. 10 is a flowchart showing a flow of the agreement/adjustment process executed in Step 903 in FIG. 9.

In Step 1001, the invitation/application management unit 101 identifies the utilization project corresponding to the application request accepted in Step 902 in FIG. 9. Here, the utilization project of the solution product included in the application information received from the client 2 is acquired, and thus the utilization project committed by the user at the time of application to the solution product can be identified.

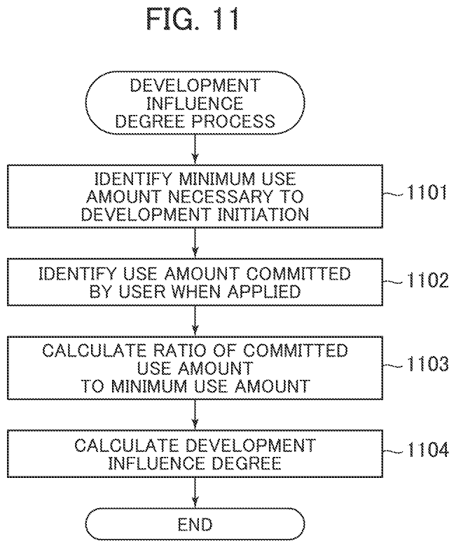

In Step 1002, a development influence degree calculation process is performed by the development influence degree calculation unit 104. Here, the development influence degree based on the utilization project identified in Step 1001 is calculated, and the calculated result is reflected in the development influence degree field 305 in the application table 112 in FIG. 3 or the development influence degree field 406 in the project/result table 113 in FIG. 4. Note that the detail of the development influence degree calculation process executed in Step 1002 will be described later with reference to FIG. 11.

In Step 1003, the contract conditions between the developer and the user are decided based on the development influence degree calculated in Step 1002 by the contract condition decision unit 105. Here, reference is made to information stored in the entries of the contract condition decision policy field 802 in the contract condition decision policy table 117 in FIG. 8, and thus the policy regarding the decision of the contract conditions is acquired. The contract conditions that have to be concluded between the developer and the user at the time of using the solution product to which the user applies are decided according to the acquired policy based on the development influence degree calculated by the development influence degree calculation unit 104 in Step 1002. The decided contract conditions are transmitted from the server 1 to the clients 2 operated by the developer of the solution product and the user (applicant), and the contract conditions are presented to both of the developer and the user on these clients 2.

In Step 1004, it is determined whether the agreement is made between the developer and the user to the contract conditions decided in Step 1003. Here, the developer and the user perform a predetermined operation to the clients 2, it is determined whether to show the will of agreement to the presented contract conditions. As a result, in the case in which both of the developer and the user show the will of agreement, it is determined that the agreement is made, and the process goes to Step 1005, whereas in the case in which at least one shows the will of dis agreement, it is determined that the agreement is not made, and the process goes to Step 1006. Note that a configuration may be provided in which the developer and the user can edit the presented contract conditions at this time and the contract conditions are adjusted before the agreement.

In Step 1005, the invitation/application management unit 101 temporarily adopts the application from the user to the use of the solution product, and temporarily confirms the utilization project of the solution product committed by the user at the time of application. Thus, the application status of the user to the case is set to “temporary confirmation”, and is reflected in the application status field 306 in the application table 112 in FIG. 3. After the process in Step 1005 is executed, the invitation/application management unit 101 ends the agreement/adjustment process in the flowchart shown in FIG. 10.

In Step 1006, the invitation/application management unit 101 does not adopt the application from the user to the use of the solution product, and discards the utilization project of the solution product committed by the user at the time of application. Thus, the entry corresponding to the application is removed from the application table 112 in FIG. 3. After the process in Step 1006 is executed, the invitation/application management unit 101 ends the agreement/adjustment process in the flowchart shown in FIG. 10.

FIG. 11 is a flowchart showing a flow of the development influence degree calculation process executed in Step 1002 in FIG. 10.

In Step 1101, the development influence degree calculation unit 104 identifies the minimum use amount necessary for the developer to initiate the development of the solution product on the solution product corresponding to the utilization project identified in Step 1001 in FIG. 10. Here, for example, reference is made to information stored in the entry corresponding to the solution product in the development initiation condition field 206 in the invitation table 111 in FIG. 2, and thus the minimum use amount necessary for the initiation of development can be identified.

In Step 1102, the development influence degree calculation unit 104 identifies the use amount (committed use amount) committed by the user at the time of application on the minimum use amount necessary for the initiation of development identified in Step 1101. Here, for example, reference is made to information stored in the entry corresponding to the application in the use commitment field 304 in the application table 112 in FIG. 3, and thus the use amount of the solution product that is planned by the user at the time of application and committed to the developer can be identified as the committed use amount. Alternatively, a configuration may be provided in which the use amount of the solution product that is planned by the user at the time of application and committed to the developer based on the information stored in the use commitment field 304 is stored beforehand in the use amount planned value field 405 in the project/result table 113 in FIG. 4, and thus reference is made to the use amount planned value field 405 to identify the committed use amount.

In Step 1103, the development influence degree calculation unit 104 calculates a ratio of the committed use amount to the minimum use amount based on the minimum use amount identified in Step 1101 and the committed use amount identified in Step 1102.

In Step 1104, the development influence degree calculation unit 104 calculates the development influence degree to the utilization project of the solution product in the application based on the ratio of the committed use amount to the minimum use amount calculated in Step 1103. Here, for example, the calculated result of the ratio of the committed use amount to the minimum use amount is multiplied by a preset conversion factor, and thus the development influence degree can be calculated. Note that when the development influence degree can be appropriately calculated based on the ratio of the committed use amount to the minimum use amount, the development influence degree may be calculated by another method. After the process in Step 1104 is executed, the obtained calculated result of the development influence degree is reflected in the development influence degree field 305 in the application table 112 in FIG. 3 or the development influence degree field 406 in the project/result table 113 in FIG. 4, and then the development influence degree calculation process shown in the flowchart of FIG. 11 is ended.

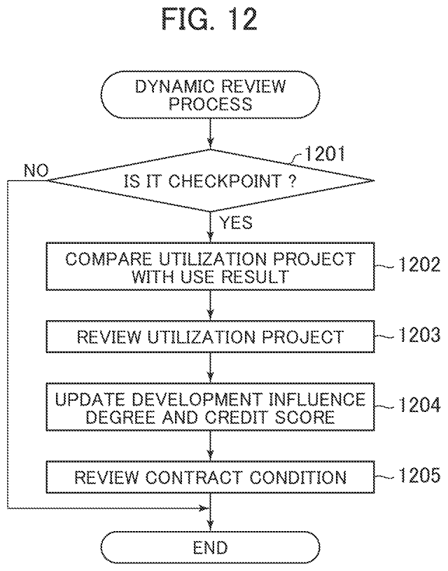

FIG. 12 is a flowchart showing a flow of a dynamic review process executed for dynamically reviewing the utilization project or the contents of the contract corresponding to the use result after the use of the solution product is started. For example, when the use of the developed solution product is started, the process shown in the flowchart of FIG. 12 is executed at fixed intervals on the users using the solution product.

In Step 1201, the project/result management unit 102 determines whether the present point in time is a checkpoint. The checkpoint expresses a breakpoint of time preset corresponding to the timing of reviewing the development influence degree or the contract, and a checkpoint is set for every fixed period, for every month, for example. In the case in which the present point in time is the timing corresponding to a checkpoint, the process goes to Step 1202, whereas in the case in which the present point in time is not the timing, the dynamic review process shown in the flowchart of FIG. 12 is ended. Alternatively, a configuration may be provided in which a predetermined condition is set as a checkpoint, and it is determined that the timing is the checkpoint when the condition is satisfied.

In Step 1202, the project/result management unit 102 compares the utilization project of the solution product with the use result between the users. Here, for example, in the project/result table 113 in FIG. 4, the values of the use amount stored in the entries corresponding to the user in the use amount planned value field 405 and the use amount result value field 409 are compared with each other, the difference or ratio between these values are calculated, and thus the utilization project can be compared with the use result.

In Step 1203, the project/result management unit 102 reviews the utilization project of the solution product by the users based on the comparison result in Step S1202. Here, for example, in the case in which a gap between the utilization project and the use result is a predetermined value or more, the utilization project is changed corresponding to the use result, and thus the utilization project is reviewed. At this time, the range of reviewing the utilization project may be restricted such that a swing from the original utilization project falls in a certain range. The utilization project after reviewed is stored as the utilization project to the next checkpoint in the use amount planned value field 405 in the project/result table 113 in FIG. 4.

In Step 1204, the development influence degree and the credit score are updated by the development influence degree calculation unit 104 and the credit score calculation unit 103 based on the utilization project reviewed in Step 1203 and the use result used for comparison with the utilization project before reviewed in Step S1202. The development influence degree can be calculated by a method similar to the method described in FIG. 11, for example. However, in Step 1102 in FIG. 11, the use amount of the solution product committed by the user at the time of application is used. However, in Step 1204, the development influence degree is calculated using the planned value of the use amount in the utilization project reviewed in Step S1203 instead. On the other hand, the credit score can be calculated using a predetermined arithmetic expression, for example, based on the difference or ratio between the utilization project and the use result. The results of the calculation of the development influence degree and the credit score obtained in Step S1204 are respectively reflected in the development influence degree field 410 in the project/result table 113 in FIG. 4 and the credit score field 502 in the credit score table 114 in FIG. 5. By performing such processing for every user, the development influence degree and the credit score can be updated.

In Step 1205, the contract conditions are reviewed by the contract condition decision unit 105 based on the comparison result between the utilization project and the use result performed in Step S1202 and the development influence degree and the credit score updated in Step 1204. Here, for example, in the contract conditions table 115 in FIG. 6, reference is made to information stored in the entry corresponding to the user in the reward condition field 604 or the penalty condition field 605, and the reward conditions or the penalty conditions is acquired. The reward offered to the user by the developer or the penalty charged to the user by the developer is then decided based on these conditions and the comparison result between the utilization project and the use result. Note that the application of any of the reward and the penalty can be decided depending on the comparison result between the utilization project and the use result in Step 1203, for example. At this time, the reward and the penalty may be applied simultaneously. For example, in the contract condition decision policy table 117 in FIG. 8, information stored in the entries in the contract condition decision policy field 802 is compared with the updated development influence degree or the updated credit score, and in the case in which any contract condition is satisfied, the adoption of the contract condition is decided. The reward conditions, the penalty, and the contract conditions thus decided are combined, and thus the contract conditions after reviewed can be decided. After the process in Step 1205 is executed, the dynamic review process shown in the flowchart of FIG. 12 is ended.

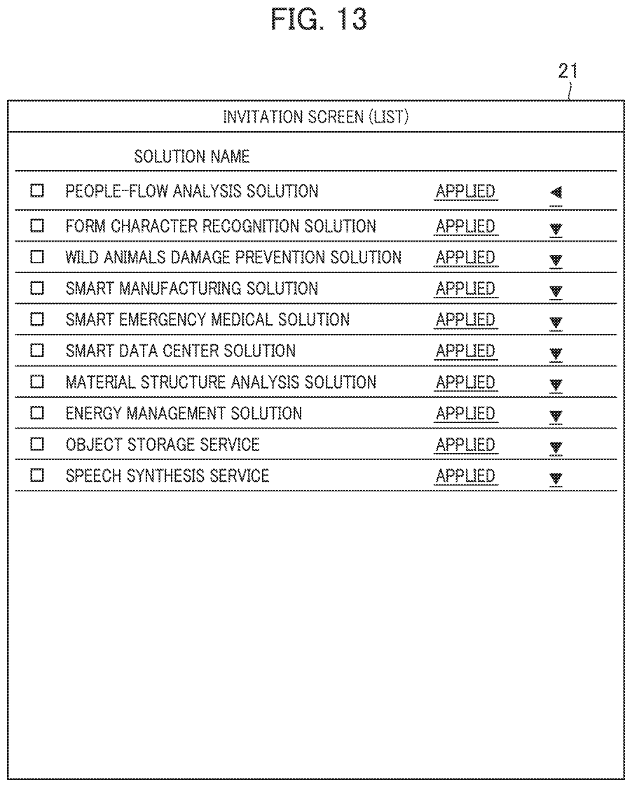

Next, examples of screens displayed on the client 2 will be described below with reference to FIGS. 13 to 15.

FIG. 13 is a diagram showing an example of the list display of the invitation screen 21 displayed on the client 2. The screen in FIG. 13 displays a list of pieces of information relating to the cases under invitation of the user of the solution product by the developer in the market place system of the present embodiment.

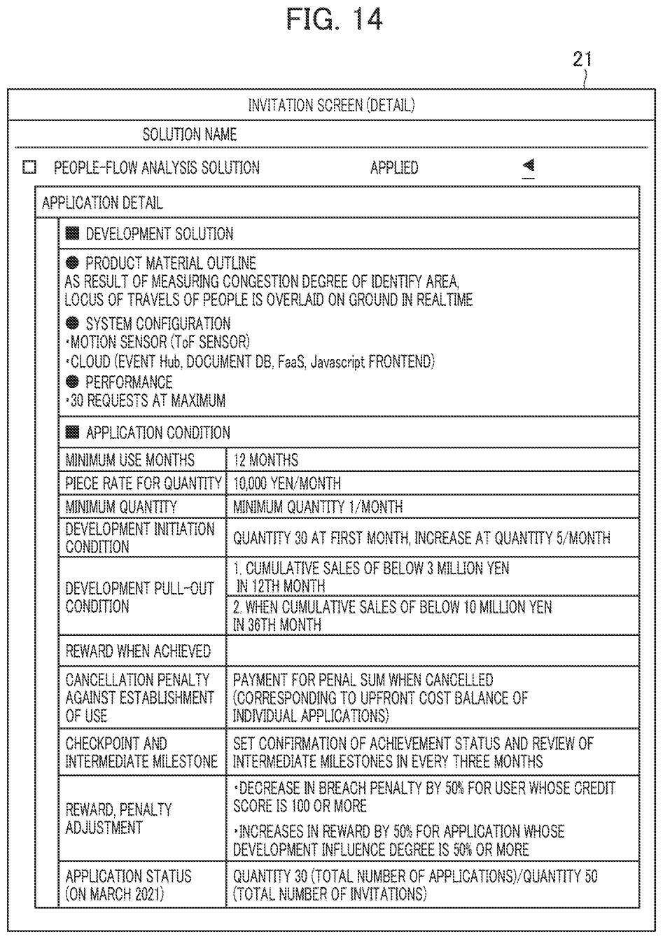

FIG. 14 is a diagram showing an example of detailed display of the invitation screen 21 displayed on the client 2. The screen in FIG. 14 displays detailed information relating to the case under invitation of the user of the solution product by the developer in the market place system of the present embodiment.

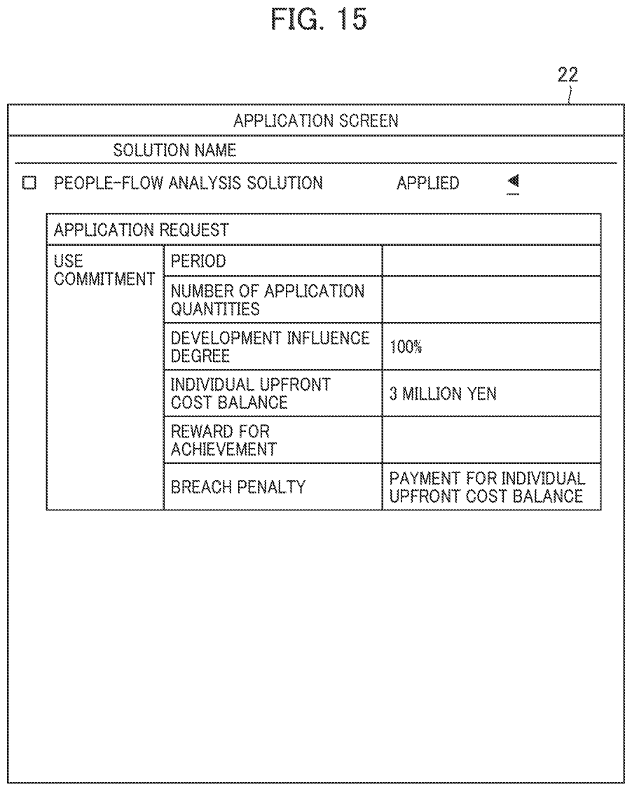

FIG. 15 is a diagram showing an example of the application screen 22 displayed on the client 2. The application screen in FIG. 15 displays information that has to be confirmed by the user who applies a solution product selected as an application destination in the market place system of the present embodiment.

After the user of the solution product selects a given case on the invitation screen 21 in FIGS. 13 and 14, and conducts a predetermined operation to the client 2, the application screen 22 as shown in FIG. 15 is displayed on the client 2, for example. After confirming necessary information on the application screen 22, the user further conducts a predetermined operation on the client 2, the client 2 transmits an application request to the server 1, and the server 1 receives the application request in Step 902 in FIG. 9. Thus, the application to the solution product selected by the user is performed.

According to the embodiment of the present invention described above, the following operations and effects are exerted.

(1) The server 1 is an information processor that assists intermediation between a developer who develops a solution product and a user who uses the solution product, and the information processor executes the application reception process shown in the flowchart in FIG. 9, and offers a market place that performs a transaction involved in the use of the solution product to the developer and the user prior to the development of the solution product. With this configuration, it is possible to perform intermediation assistance between the developer and the user prior to the development of the solution product.

(2) The server 1 includes the invitation/application management unit 101 that performs a use invitation using the solution product on the market place based on invitation information registered beforehand in the developer, that accepts an application by the user to the use invitation, and that sets the utilization project of the solution product by the user, the development influence degree calculation unit 104 that calculates a development influence degree of the solution product on the utilization project, and the contract condition decision unit 105 that decides a contract condition between the developer and the user based on the development influence degree. With this configuration, it is possible to appropriately assists a contract that has to be concluded between the developer and the user in the development of the solution product in consideration of the influence degree of the utilization project preset by the user affecting the development of the solution product.

(3) As shown in the development initiation condition field 206 in the invitation table 111 in FIG. 2, the invitation information includes information relating to the development initiation condition of the solution product. In the case in which the development initiation condition is not achieved, the invitation/application management unit 101 continues the use invitation (Step 908), whereas in the case in which the development initiation condition is achieved, the use invitation is ended (Step 905). With this configuration, in the case in which the development initiation condition is achieved, the use invitation is closed, and it is possible to promote the initiation of the development of the solution product to the developer.

(4) As shown in the invitation period field 205 in the invitation table 111 in FIG. 2, the invitation information includes information relating to an invitation period. In the case in which the invitation period is expired, the invitation/application management unit 101 ends the use invitation even though the development initiation condition is not achieved (Step 910). With this configuration, in the case in which the preset invitation period elapses, the use invitation is canceled, and it is possible to promote pull-out from the development of the solution product to the developer.

(5) As shown in the development initiation condition field 206 in the invitation table 111 in FIG. 2, the invitation information includes information relating to the minimum use amount of the solution product necessary for the initiation of the development of the solution product. The invitation/application management unit 101 establishes a utilization project including the use amount of the solution product committed to the developer by the user at the time of application. The development influence degree calculation unit 104 calculates the development influence degree based on the ratio of the use amount of the solution product to the minimum use amount (Step 1103, 1104). With this configuration, it is possible to calculate the development influence degree depending on the influence degree of the utilization project affecting the development of the solution product.

(6) The server 1 includes the project/result management unit 102 that manages the utilization project and the use result of the solution product by the user. With this configuration, after the development of the solution product is completed and the operation is started, it is possible to appropriately manage the initial utilization project and the use result corresponding to the actual operation by the users.

(7) The contract condition decision unit 105 decides the reward or the penalty to the user based on the comparison result between the utilization project and the use result, and updates the contract conditions based on the decided reward or penalty (Step 1205). With this configuration, the reward or the penalty can be appropriately determined corresponding to the status of the use of the solution product by the users, and the contract conditions can be updated. As a result, it is possible to perform the operation of the solution product of high satisfaction to both of the developer and the user.

(8) The server 1 includes the credit score calculation unit 103 that calculates the credit score of the user based on the comparison result between the utilization project and the use result. The project/result management unit 102 updates the utilization project based on the comparison result between the utilization project and the use result (Step 1203), and the development influence degree calculation unit 104 updates the development influence degree based on the updated utilization project (Step 1204). The contract condition decision unit 105 updates the contract conditions based on the credit score or the updated development influence degree (Step 1205). With this configuration, the contract conditions can be updated according to the credit score in which the status of the use of the solution product by the users is appropriately reflected or the development influence degree. As a result, even in the case in which a gap occurs between the preset utilization project in the application of the user to the use of the solution product and the use result after the operation is started, it is possible to perform the operation of the solution product of highly satisfaction to both of the developer and the user.

In addition, the present invention is not limited to the embodiment, and can be carried out using given components within the scope not deviating from the gist.

The embodiment and the exemplary modifications are merely examples, and the present invention is not limited to these contents as long as the features of the invention is not impaired. In the description above, various embodiments and exemplary modifications are described. However, the present invention is not limited to these contents. Other forms that are conceivable within the range of technological ideas of the present invention the technology are also included in the scope of the present invention.

What is claimed is:

1. An information processor that assists intermediation between a developer who develops a solution product and a user who uses the solution,
wherein prior to development of the solution product, a market place that performs a transaction involved in use of the solution product is offered to the developer and the user.

2. The information processor according to claim 1,
wherein the information processor comprises:
an invitation/application management unit that performs use invitation using the solution product on the market place based on invitation information registered beforehand in the developer, that accepts an application by the user to the use invitation, and that sets a utilization project of the solution product by the user;
a development influence degree calculation unit that calculates a development influence degree of the solution product on the utilization project; and
a contract condition decision unit that decides a contract condition between the developer and the user based on the development influence degree.

3. The information processor according to claim 2,
wherein: the invitation information includes information relating to a development initiation condition of the solution product; and
the invitation/application management unit continues the use invitation when the development initiation condition is not achieved, whereas the invitation/application management unit ends the use invitation when the development initiation condition is achieved.

4. The information processor according to claim 3,
wherein: the invitation information includes information relating to an invitation period; and
the invitation/application management unit ends the use invitation when invitation period is expired even though the development initiation condition is not achieved.

5. The information processor according to claim 2,
wherein: the invitation information includes information relating to a minimum use amount of the solution product necessary for initiation of development of the solution product;
the invitation/application management unit sets the utilization project including a use amount of the solution product committed to the developer by the user at time of application; and
the development influence degree calculation unit calculates the development influence degree based on a ratio of the use amount to the minimum use amount.

6. The information processor according to claim 2, comprising
a project/result management unit that manages the utilization project and a use result of the solution product by the user.

7. The information processor according to claim 6,
wherein the contract condition decision unit decides a reward or a penalty to the user based on comparison result between the utilization project and the use result, and updates the contract condition based on the decided reward or the decided penalty.

8. The information processor according to claim 6, comprising
a credit score calculation unit that calculates a credit score of the user based on a comparison result between the utilization project and the use result,
wherein the contract condition decision unit updates the contract condition based on the credit score.

9. The information processor according to claim 6,
wherein: the project/result management unit updates the utilization project based on a comparison result between the utilization project and the use result;
the development influence degree calculation unit updates the development influence degree based on the updated utilization project; and
the contract condition decision unit updates the contract condition based on the updated development influence degree.

10. A method that offers a market place involved in a transaction of a solution product to a developer who develops the solution product and a user who uses the solution product using a computer prior to development of the solution product and that assists intermediation between the developer and the user,
wherein the computer:
performs a use invitation using the solution product on the market place based on invitation information registered beforehand in the developer;
accepts an application by the user to the use invitation and sets a utilization project of the solution product by the user;
calculates a development influence degree of the solution product on the utilization project; and
decides a contract condition between the developer and the user based on the development influence degree.
